(19) United States
(12) Patent Application Publication
(10) Pub. No.: US 2011/0084042 A1
(43) Pub. Date: Apr. 14, 2011

(54) SHELF ELEMENTS, AND SHELF COMPRISING THE SAME

(76) Inventors: Malte Ahlert, Huerth (DE); Thomas Reichel, Duesseldorf (DE)

(21) Appl. No.: 12/744,217

(22) PCT Filed: Nov. 20, 2008
(86) PCT No.: PCT/DE08/01922

§ 371 Date: Dec. 22, 2010

(30) Foreign Application Priority Data
Nov. 22, 2007 (DE) 102007056497.1

(51) Int. Cl. A47B 47/00; B23P 11/00

(52) U.S. Cl. 211/194; 211/189; 29/428

(57) ABSTRACT

The invention relates to a shelf element 1 being provided for releasable connection to at least one further shelf element 1, comprising at least two parallel plates that are spaced from each other and at least one plate that connects said parallel plates, wherein at least one of the plates is a mounting plate which is provided with and/or at least partly provides at least one device for connection to the further shelf element 1. With the shelf element 1 according to the invention, the device for connection to the further shelf element 1 has the form of a slot. Furthermore, the device is provided for receiving a connecting element 21 which allows for connecting two shelf elements 1. Moreover, the invention relates to a shelf 20 comprising at least two of said shelf elements 1, wherein said self elements 1 are releasably mounted to each other via at least one connecting element 21.

The invention relates to a shelf element being provided for releasable connection to at least one further shelf element, comprising at least two parallel plates that are spaced from each other and at least one plate that connects said parallel plates, wherein at least one of the plates is a mounting plate which is provided with and/or at least partly provides at least one device for connection to the further shelf element. The invention further relates to a shelf comprising at least two of said shelf elements, wherein said self elements are releasably mounted to each other via at least one connecting element.

Shelves that are assembled of single shelf elements have the advantage that they allow for an individual design as the number of the single elements can be freely chosen. However, if the single elements are merely disposed side by side or on top of one another, the whole shelf is instable so that the single shelf elements can be moved relative to another when items are put in or out. Consequently, the single elements are usually screwed together or tightly mounted to each other in a different manner. But this has the disadvantage that easy redesign of the shelf, for example, to adapt it to structural changes or different needs, is not possible anymore.

Thus, there is a need for modular-built shelves with which assembling, disassembling and remodelling of the shelves can be accomplished without tools and without the use of nails, screws and the like.

For example, a box-like shelf system is known from EP-A-0 477 125, wherein single box modules are releasably connected to each other by z-shaped engagement areas which are incorporated into the edges of the modules and into which sloped contact parts of adjacent box modules engage. However, this shelf system has the disadvantage that only box modules having the same outer dimensions can be combined or connected to each other. Moreover, single modules may be moved relative to another in the longitudinal direction so that establishing a plane front without protruding modules is difficult with larger shelves.

It is the object of the invention to provide shelf elements which can be stably connected to each other and flexibly combined without tools and without using nails, screws or the like.

According to the invention, the object is achieved by providing a shelf element of the kind initially mentioned, wherein the device for connection to the further shelf element has the form of a slot. Furthermore, the device is provided for receiving a connecting element with which two shelf elements can be connected or mounted to each other. By means of the slot-shaped device for receiving a connecting element, the shelf element according to the invention can be stably and flexibly connected to other shelf elements. Here, advantageously, also shelf elements having different outer dimensions can be connected to each other to build a shelf.

In an advantageous embodiment of the invention it is provided that the slot-shaped device is a slit which is formed by the mounting plate and a mounting component that is disposed parallel to the mounting plate. Such an embodiment can be produced in a cost-effective manner and ensures a stable connection between different shelf elements. Furthermore, such an embodiment is very rigid and also resists multiple assembly, disassembly and remodelling of a shelf that is assembled of respective shelf elements. In order to precisely adjust a constant width of the slit, at least one spacer can be disposed between the mounting plate and the mounting component. This (these) spacer(s) can connect the mounting plate and the mounting component to each other, for example, in that it (they) is (are) screwed, glued or cemented to the mounting plate and/or the mounting component. Possible spacers are, for example, several smaller plates or one larger plate. The respective outer edges of the mounting plate and the mounting component should be flush with each other so that each shelf element shows a compact visual appearance. Hereby, the slit is concealed and, furthermore, the stability of the connecting element within the slot-shaped device is increased.

In a further advantageous embodiment of the invention it is provided that the slot-shaped device is a notch that is incorporated in at least one surface of said mounting plate. This embodiment can be particularly realised with thicker plates as here milling of a notch is possible. With thinner plates, the notch should be incorporated in at least one narrow side of the mounting plate so as to ensure a sufficient depth of the notch. Thus, the connecting elements can engage deep enough into the notch so as to ensure a stable connection.

In an advantageous embodiment of the invention it is provided that the mounting plate is a rear wall of the shelf element. Hereby, on the one hand a stable connection between the shelf elements can be realised and on the other hand the visual appearance of the shelf elements or the shelf is not impaired because the slot-shaped device at the front of the shelf elements and in particular on the outer edges is not visible.

In order to be able to flexibly use or combine the shelf elements, it is preferred according to the invention that the slot-shaped device extends over the entire circumference of the mounting plate.

According to the invention, the object is further achieved by providing a shelf of the kind initially mentioned, wherein the connecting element is at least partly adapted to the dimensions of the slot-shaped device for positive connection. Establishing of a positive connection between the connecting element and the slot-shaped device causes a stable connection between the shelf elements. Moreover, the possibility to mount the connecting elements within the slot-shaped device of the mounting plate in easy manner leads to a multiple-use shelf by tool-free and flexible combination of single shelf elements.

In an advantageous embodiment of the invention it is provided that at least one connecting element has flat design and a thickness which is smaller than the width of the slot-shaped device so that positive connection is possible in an easy and cost-effective manner.

In a further embodiment of the invention it is provided that at least one connecting element is formed like a hook and at least a part of the hook has a flat design and a thickness which is smaller than the width of the slot-shaped device. Such hook-shaped elements may be beneficial in addition to the already described connecting elements, for example, to fix the shelf to a wall.

For example, the shelf elements can be square or rectangular shelf boxes comprising for side walls and one rear wall. Such shelf boxes each represent a complete shelf element which can be placed or mounted in any position of the shelf. A shelf assembled of such shelf boxes or modules may be designed in a very variable manner and thus can be adapted to any different needs and requirements or conditions. For example, the shelf boxes may be provided with door panels.

The single shelf elements may also have different dimensions. Due to the construction according to the invention and the resulting possibility to variably combine the shelf elements, the dimensions of the single elements do not matter. Since the connecting elements can be placed in variable positions, it is possible in an advantageous manner to combine also shelf elements having a different size. Here, the shelf elements are preferably adapted to their desired function, for example, to receiving books, CD's, DVD's, files or the like. Accordingly, a multi-functional shelf can be provided by the combination of different shelf elements.

The uniform visual appearance and structure of the shelf according to the invention is particularly realised if the slot-shaped devices of all shelf elements are disposed such that they are congruent with each other.

The invention further comprises a kit for assembling at least one shelf element according to the invention and/or at least one shelf according to the invention. Such kit preferably comprises all parts necessary for assembling one or more shelf elements, for example, all plates including mounting plate and mounting component. Moreover, in an advantageous manner a sufficient number of connecting elements, optionally in different form, may be included in the kit according to the invention.

The invention further relates to a method for assembling at least one shelf according to the invention, wherein at least one connecting element is inserted into the slot-shaped device of at least one shelf element according to the invention and at least one further shelf element according to the invention is then fitted onto at least one connecting element so as to achieve positive fitting of the connecting element in the slot-shaped devices of both shelf elements. That is, by the method according to the invention shelf elements can be easily connected to build a shelf in a fast and variable manner.

As material for the shelf elements according to the invention, for example, wood, in particular medium density fibreboard (MDF plates), synthetic material and/or metal, may be chosen. However, basically any other material may also be used.

In the following, the invention is exemplarily described in detail with reference to the figures.

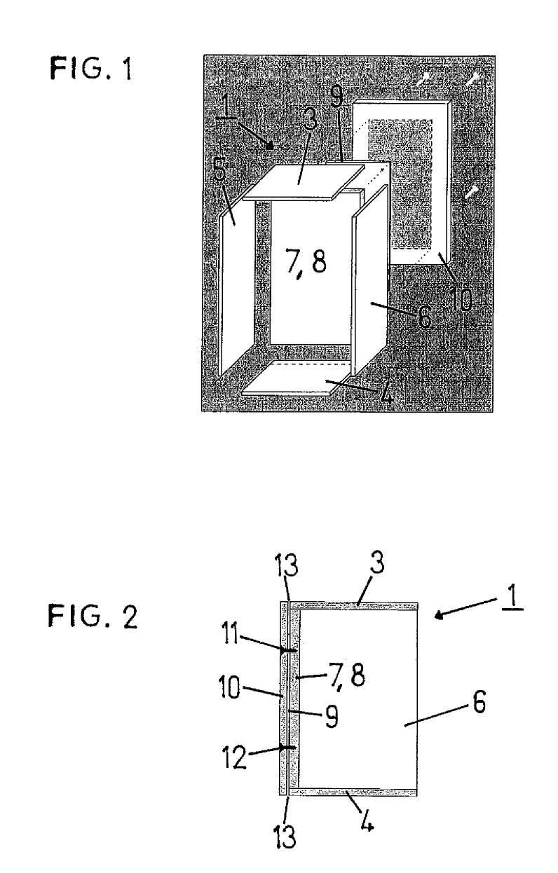

FIG. 1 shows an exploded drawing of one embodiment of the shelf element according to the invention.

FIG. 2 shows a side view of the shelf element according to FIG. 1.

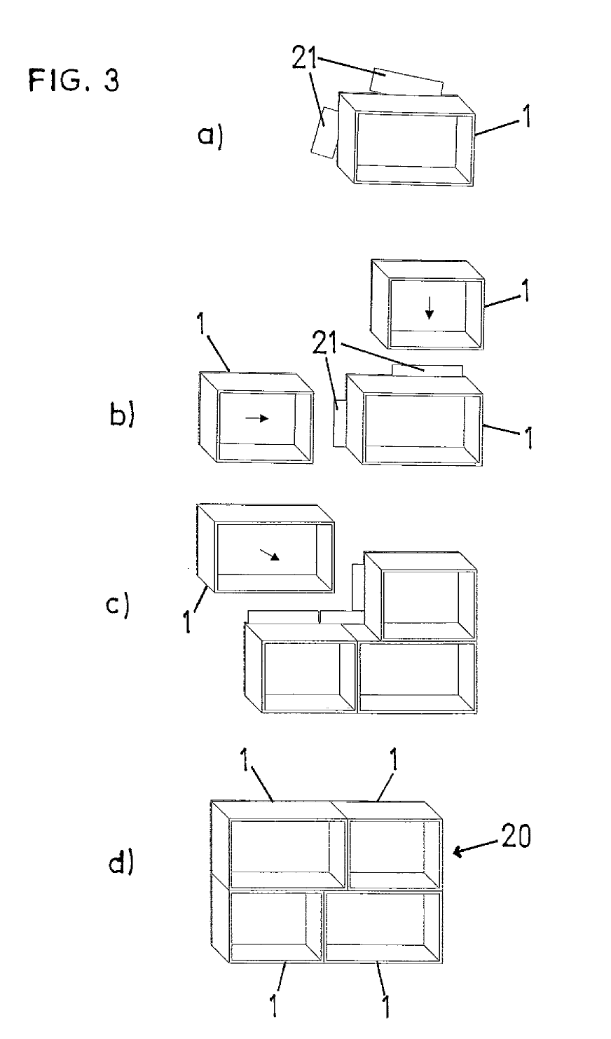

FIGS. 3a to 3d show the course of assembly of a shelf according to the invention made of four shelf elements according to the invention.

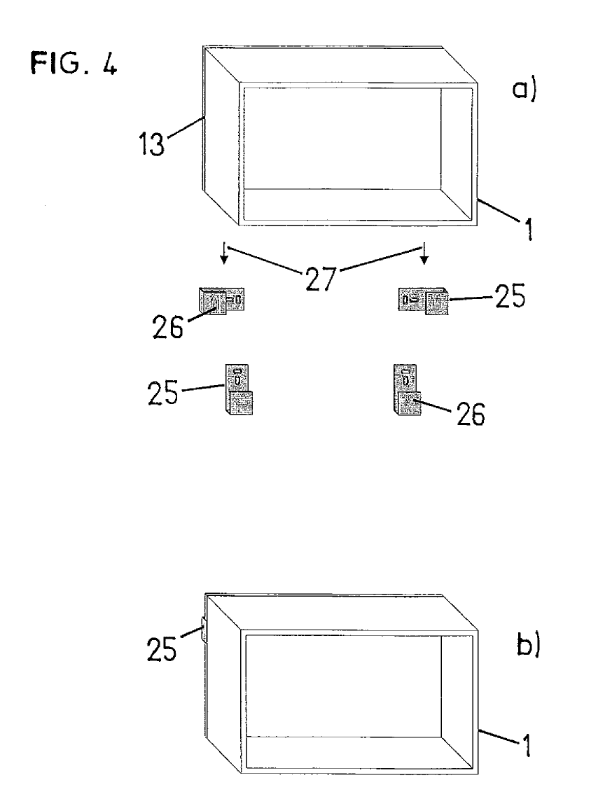

FIGS. 4a and 4b show the shelf element according to FIG. 1 including hook-like connecting elements.

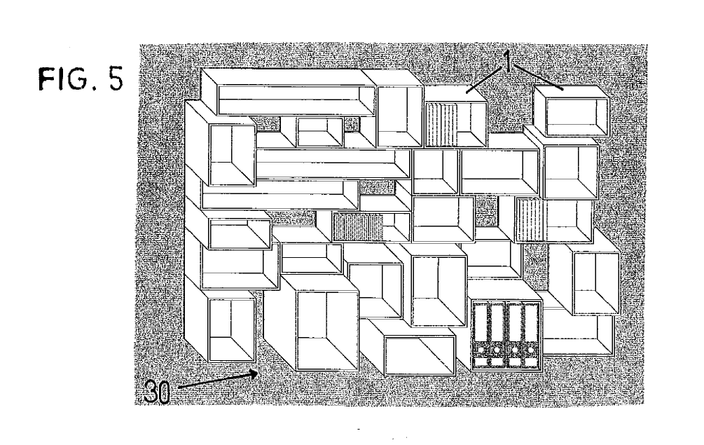

FIG. 5 shows a perspective view of one embodiment of a shelf according to the invention.

FIGS. 1 and 2 both show one embodiment of a shelf element 1 according to the invention. The shelf element 1 consists of two parallel plates 3, 4 that are spaced from each other and which are connected to each other via two also parallel disposed plates 5, 6 and a plate 7 that is disposed perpendicular thereto. Further, the shelf element 1 is a rectangular shelf box which consists of for side walls and one rear wall. The plate 7, which in this embodiment acts as mounting plate 8, is connected to a plate-like mounting component 10 via a plate-like spacer 9. In the embodiment shown here, the mounting component 10 together with the spacer 9 are screwed onto the mounting plate 8 by screws 11, 12. Alternatively, the mounting component 10, the spacer 9 and the mounting plate 8 may be glued, cemented or otherwise connected to each other. In this embodiment, the outer edges of the mounting component 10 are flush with the outer edges of plates 3, 4, 5, 6 so that it is not visible from the front view. Thus, in this case, the mounting component 10 is larger than the mounting plate 8. Depending on the construction of the shelf elements, the mounting component and the mounting plate may have the same dimensions. As the spacer 9 is smaller than the mounting component 10 and the mounting plate 8, the shelf element 1 includes a circumferential slit 13 which is provided as device for receiving connecting elements. Connecting shelf elements according to the invention by connecting elements inserted in such a slit will be described in detail with reference to FIG. 3.

FIG. 3 shows the course of assembling a shelf 20 according to the invention made of four shelf elements according to the invention. For the sake of simplification, as in FIGS. 1 and 2, these are also marked with reference number 1. At first, a shelf element 1 is provided with two flat, plate-like connecting elements 21. To this end, the connecting elements 21 are inserted into a slot-shaped device corresponding to slit 13 in FIG. 2 (FIG. 3a). The connecting elements 21 are designed and sized such that they positively engage into the slit and therefore can be stably mounted therein. Due to their size, the connecting elements 21 protrude out of the slot. Onto the protruding parts of the connecting elements 21 further shelf elements 1 may now be fixed, wherein the respective slot-shaped devices of the single connecting elements are disposed congruent with each other so that the connecting elements 21 respectively engage in the slot-shaped devices of both adjacent shelf elements (FIG. 3b). These method steps may be repeated as long as the complete shelf 20 is assembled (FIGS. 3c and 3d). As in the embodiment shown here, also shelf elements having different dimensions may be easily combined. The connecting elements 21 and the slot-shaped devices for receiving them allow for stable and flexible connection of the shelf elements 1 according to the invention to build a shelf 20 according to the invention. It is also an advantage of the invention that the connecting elements can be fixed without tools and that they are not visible within the completely assembled shelf. Preferably, the connecting elements 21 are made of wood, metal or synthetic material.

FIG. 4 shows the shelf element 1 according to the invention of FIG. 1 including hook-like connecting elements. The hooks 25 may be mounted, for example, on a wall. The shorter part 26 of each hook 25 is designed such that it can engage into the slit 13 of the shelf element 1 (FIG. 4a). In particular, the thickness or size of the material of this part 26 of each hook 25 is marginally smaller than the width of the slit 13 so that the hooks 25 can positively engage into the slit 13. When the hooks 25 are mounted on a wall or the like according to the dimensions of the shelf element 1, the shelf element 1 can be fixed onto the hooks 25 in the direction of the arrows 27, wherein the part 26 of the hooks 25 engage into the slit 13 (FIG. 4b). In this manner, a single shelf element or a complete shelf may be fixed on a wall or the like. Preferably, the hooks 25 are made of metal.

FIG. 5 shows an exemplary embodiment of a shelf 30 according to the invention. The shelf 30 consists of many shelf elements 1 according to the invention which partly have a different design or different dimensions. The shelf elements according to the invention may be variably combined with each other, wherein subsequent remodelling and/or upgrading is/are easily possible without problems.

### LIST OF REFERENCE SIGNS

1 Shelf element
2
3 Plate
4 Plate
5 Plate
6 Plate
7 Plate
8 Mounting plate
9 Spacer
10 Mounting component
11 Screw
12 Screw
13 Slit
20 Shelf
21 Connecting element
25 Hook
26 Portion
27 Arrow
30 Shelf

1. Shelf element for releasable connection to at least one further shelf element, comprising
at least two parallel plates that are spaced from each other and at least one plate that connects said parallel plates, wherein at least one of the plates is a mounting plate which is provided with and/or at least partly provides at least one device for connection to the at least one further shelf element, wherein said device is slot-shaped and is provided for receiving a connecting element.

2. Shelf element according to claim 1, wherein said slot-shaped device is a which is formed by said mounting plate and a mounting component that is disposed parallel to said mounting plate.

3. Shelf element according to claim 2, wherein at least one spacer is disposed between said mounting plate and said mounting component.

4. Shelf element according to claim 3, wherein said spacer connects said mounting plate to said mounting component.

5. Shelf element according to claim 2, wherein respective outer edges of said mounting plate and said mounting component are flush with each other.

6. Shelf element according to claim 1, wherein said slot-shaped device is a notch that is incorporated in at least one surface of said mounting plate.

7. Shelf element according to claim 6, wherein said notch is incorporated in at least one narrow side of said mounting plate.

8. Shelf element according to claim 1 wherein said mounting plate is a rear wall of said shelf element.

9. Shelf element according to claim 1, wherein said slot-shaped device extends over the entire circumference of said mounting plate.

10. Shelf comprising at least two shelf elements according to claim 1, wherein said self elements are releasably mounted to each other via at least one connecting element, and wherein said connecting element is at least partly adapted to the dimensions of the slot-shaped device for positive connection.

11. Shelf according to claim 10, wherein at least one connecting element has a flat design and a thickness which is smaller than a width of the slot-shaped device.

12. Shelf according to claim 10, wherein at least one connecting element has a form of a hook and at least a part of said hook has a flat design and a thickness which is smaller than a width of the slot-shaped device.

13. Shelf according to claim 10, wherein said shelf elements are square or rectangular shelf boxes comprising four side walls and one rear wall.

14. Shelf according to claim 10, wherein said shelf elements have different dimensions.

15. Shelf according to claim 10, wherein the slot-shaped devices of all shelf elements are disposed such that they are congruent with each other.

16. Kit for assembling at least one shelf element according to claim 1.

17. Method for assembling at least one shelf according to claim 10, wherein at least one connecting element is inserted into the slot-shaped device of at least one shelf element according to claim 1 and at least one of said further shelf element is then fitted onto at least one connecting element so as to achieve positive fitting of the connecting element in the slot-shaped devices of both shelf elements.

18. Kit for assembling at least one shelf according to claim 10.
